(19) United States
(12) Patent Application Publication
(10) Pub. No.: US 2007/0285090 A1
(43) Pub. Date: Dec. 13, 2007

(54) PHASE CYCLING METHOD AND MAGNETIC RESONANCE IMAGING APPARATUS

(76) Inventor: Yoshikazu Ikezaki, Tokyo (JP)

Correspondence Address: Patrick W. Rasche;Armstrong Teasdale LLP, Suite 2600, One Metropolitan Square, St. Louis, MO, 63102, US

(21) Appl. No.: 11/757,802

(22) Filed: Jun. 4, 2007

(30) Foreign Application Priority Data
Jun. 7, 2006 (JP) 2006-158883

(51) Int. Cl. G01V 3/00

(52) U.S. Cl. 324/307; 324/309

(57) ABSTRACT

The present invention provides a phase cycling method capable of obtaining images based on the phase cycling method in the same time as when no phase cycling method is used, and a magnetic resonance imaging apparatus therefor. In the phase cycling method, the amount of increment/decrement in the phase of each α° pulse (i.e., RF transmission phase) is changed upon data acquisition in a positive low frequency domain on a k space and upon data acquisition in a negative low frequency domain to carry out phase cycling. The amount of increment/decrement in the RF transmission phase changes so as to differ at the start of data acquisition and the end of data acquisition. The amount of its change varies between 0 and a predetermined value. The predetermined value is set to such a degree that the amount of increment/decrement in the RF transmission phase is gradually changed, in such a manner that a steady state can be maintained on a pseudo basis. A method for determining the predetermined value is not limited by or to the present invention. For example, values obtained empirically can be used.

### CROSS REFERENCE TO RELATED APPLICATIONS

This application claims the benefit of Japanese Patent Application No. 2006-158883 filed Jun. 7, 2006.

### BACKGROUND OF THE INVENTION

The present invention relates to a phase cycling method for reducing a band artifact, and a magnetic resonance imaging apparatus using the same.

There has been a demand for the generation of an accurate image in a short period of time in a magnetic resonance imaging apparatus (MRI apparatus).

An SSFP pulse sequence of a gradient echo system which rewinds a phase shift of transverse magnetization generated in a TR by a gradient magnetic filed within the TR, i.e., before excitation of the following RF pulse is generally called by the name such as FISP (Fast Imaging with Steady-state Precession) or FIESTA (Fast Imaging Employing Steady-state Acquisition). The SSTP (Steady State Frequency Precession) means steady-state free precession and has an advantage that when spins in a subject is brought to an SSFP state to perform a scan, a signal strong in strength and high in contrast can be obtained in a short scan time. The transmission phase of an RF pulse of the general FISP is formed with steady-state SSTP by a repetition of 0-180-0-180 (deg) for every excitation.

On the other hand, a problem arises in that a band-like low signal domain susceptible to magnetic-field ununiformity and called band artifact is generated.

As a method for resolving the band artifact, there is known a phase cycling method disclosed in a patent document 1 or the like. The phase cycling method is a technique wherein spins in a subject to be imaged or photographed are respectively brought to an SSFP state to perform magnetic resonance imaging, and echo data (MR signals) acquired or collected using RF pulses that remain unchanged in phase, and echo data collected using RF pulses whose phases alternately change in the form of 0 and π are added (or subtracted from each other) to produce an image.

Described specifically, when the number of additions is twice (hereinafter called 2Nex), for example, an image is first obtained in an RF transmission phase of 0-0-0-0 (deg) is obtained. Next, an image is obtained in an RF transmission phase of 0-180-0-180 (deg). Both images are combined together to reduce a band artifact. In this case, increases in the respective RF transmission phases are 0° and 180°. 3Nex and 4Nex are also considered similarly.

In the phase cycling method, 360° are equally divided to determine increases in RF transmission phase. Thus, the increases in RF transmission phase are changed to perform sampling plural times, whereby plural images can be obtained by shifting the position where each band artifact occurs. Further, the influence of the band artifact is reduced by combining these sampled images.

[Patent Document 1] Japanese Unexamined Patent Publication No. 2004-121466

In the phase cycling method, such data acquisition is performed while the phase of an RF pulse is being changed by predetermined number of times during one scan.

Therefore, a disadvantage is brought about in that there is a need to wait until magnetization reaches a steady state each time the RF pulse is changed, and hence a scan time becomes longer.

### SUMMARY OF INVENTION

Therefore, an object of the present invention is to provide a phase cycling method capable of obtaining images based on the phase cycling method in the same time as the case where the phase cycling method is not used, and a magnetic resonance imaging apparatus therefor.

In order to attain the above object, there is provided a phase cycling method of a first invention, which is suitable for use in an SSFP pulse sequence of a gradient echo system which rewinds a phase shift of transverse magnetization generated in a TR by a gradient magnetic field before excitation of the following RF pulse, comprising the step of changing the amount of increment/decrement in an RF transmission phase between a data collection start time and a data collection end time in such a manner that the amount of increment/decrement in the RF transmission phase differs upon data collection in a positive low frequency domain on a k space and upon data collection in a negative low frequency domain.

There is provided a magnetic resonance imaging apparatus of a second invention, using a phase cycling method suitable for use in an SSFP pulse sequence of a gradient echo system which rewinds a phase shift of transverse magnetization generated in a TR by a gradient magnetic field before excitation of the following RF pulse, wherein the amount of increment/decrement in an RF transmission phase is changed between a data collection start time and a data collection end time in such a manner that the amount of increment/decrement in the RF transmission phase differs upon data collection in a positive low frequency domain on a k space and upon data collection in a negative low frequency domain.

According to the present invention, there can be provided a phase cycling method capable of obtaining images based on the phase cycling method in the same time as when no phase cycling method is used, and a magnetic resonance imaging apparatus therefor.

Further objects and advantages of the present invention will be apparent from the following description of the preferred embodiments of the invention as illustrated in the accompanying drawings.

### BRIEF DESCRIPTION OF THE DRAWINGS

FIG. 1 is a schematic block diagram showing an MRI apparatus 100 of the present invention.

FIG. 2 shows a pulse sequence for scan in an SSFP state.

FIGS. 3a and 3b are diagrams for describing changes in the amount of increment/decrement in an RF transmission phase of the MRI apparatus 100 according to the present embodiment.

FIGS. 4a and 4b are diagrams showing the relationship between time and positions where data acquisition on a k space is being performed.

FIG. 5 is a diagram showing one example illustrative of the elapse of time, changes in the amount of increment/decrement in an RF transmission phase, and scanned locations in a k space.

FIG. 6 is a diagram showing one example of the relationship between positions and time at which data acquisition on a k space is being performed upon data acquisition in a modification 1.

FIG. 7 is a diagram showing the sequence of acquisition of data on a ky-kz plane in a k space upon a three-dimensional scan in a modification 2.

FIG. 8 is a diagram showing one example of a trajectory for acquisition of data in the third quadrant in the modification 2.

FIG. 9 shows one example of the relationship between the elapse of time, changes in the amount of increment/decrement in an RF transmission phase, and positions where data acquisition on a k space is being performed.

FIG. 10 is a diagram for describing another example of a change in the amount of increment/decrement in an RF transmission phase of the MRI apparatus 100.

### DETAILED DESCRIPTION OF THE INVENTION

An MRI (Magnetic Resonance Imaging) apparatus 100 using a phase cycling method according to the present embodiment will be explained.

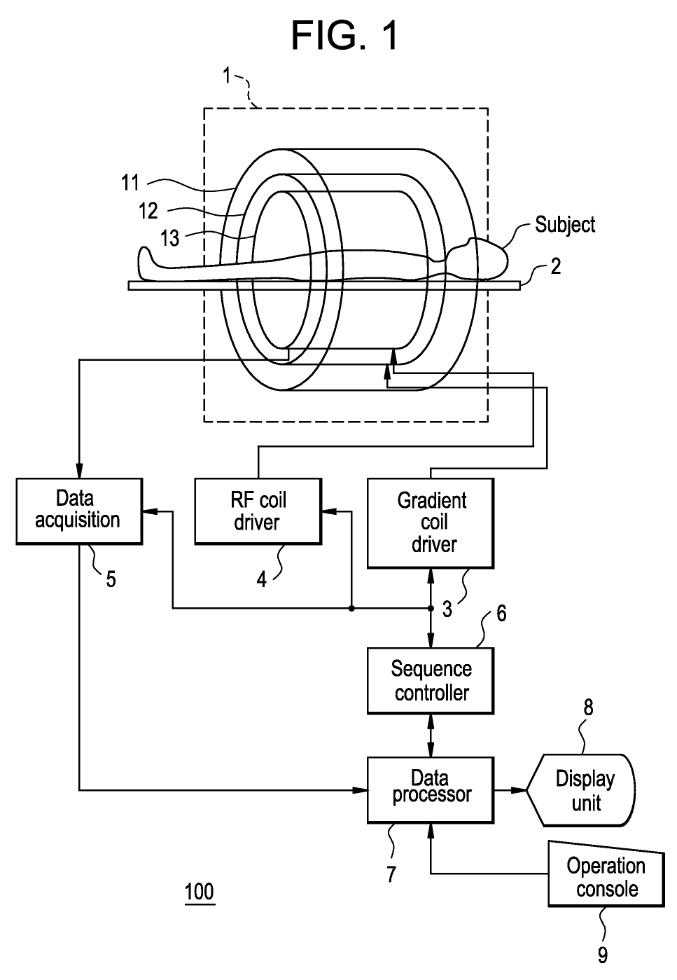

FIG. 1 is a schematic block diagram showing the MRI apparatus 100 of the present invention.

A configuration of the MRI apparatus 100 of the present invention and its basic operation will be explained with reference to FIG. 1.

The MRI apparatus 100 of the present invention includes a magnet system 1, a data acquisition system or unit 5, an RF coil driver 4, a gradient coil driver 3, a sequence controller 6, a data processor 7, a display unit 8, and an operation unit or console 9.

The magnet system 1 has a main magnetic field coil unit 11, a gradient coil unit 12 and an RF coil unit 13. These coil units have approximately cylindrical shapes respectively and are coaxially laid out one another within an approximately columnar internal space (bore).

A photographed or imaged object (or imaged target or subject) SU such as a human body or the like to be imaged or photographed using a magnetic resonance phenomenon is placed on the cradle 2 and moved within the bore in the magnet system 1 according to an imaging region by unillustrated conveying means.

The main magnetic field coil unit 11 forms a static magnetic field in the internal space of the magnet system 1. The direction of the static magnetic field is approximately parallel to the direction of a body axis of the subject SU to be imaged, and the static magnetic field forms a horizontal magnetic field.

The main magnetic field coil unit 11 is normally constituted using a superconductive coil but is not limited to the superconductive coil. The main magnetic field coil 11 may be constituted using a normal conductive coil or the like.

The gradient coil unit 12 generates three types of gradient magnetic fields for causing static magnetic field strengths formed by the main magnetic field coil unit 11 to have gradients respectively toward three axes orthogonal to one another, i.e., a slice axis, a phase axis and a frequency axis. In order to enable the occurrence of such gradient magnetic fields, the gradient coil unit 12 has unillustrated gradient coils of three systems. The gradient coil driver 3 is connected to the gradient coil unit 12. The gradient coil driver 3 supplies a drive signal to the gradient coil unit 12 to generate gradient magnetic fields. The gradient coil driver 3 has unillustrated drive circuits of three systems in association with the three-system gradient coils in the gradient coil unit 12.

The gradient magnetic field in the slice-axis direction is called a slice gradient magnetic field, the gradient magnetic field in the phase-axis direction is called a phase encode gradient magnetic field (or phase encode gradient magnetic field), and the gradient magnetic field in the frequency-axis direction is called a readout gradient magnetic field (or frequency encode gradient magnetic field), respectively.

When the coordinate axes orthogonal to one another in a static magnetic space are defined as an x axis, a y axis and a z axis in a three-dimensional orthogonal coordinate system, any axis can be defined as the slice axis. In the present embodiment, the direction of the body axis of the subject SU as the slice axis is defined as the z-axis direction, one of the remaining two axes is defined as the phase axis, and the other thereof is defined as the frequency axis.

Incidentally, the slice axis, the phase axis and the frequency axis are capable of allowing the x, y and z axes to have arbitrary gradients respectively while orthogonality therebetween is being held.

The RF coil driver 4 is connected to the RF coil unit 13. The RF coil driver 4 supplies a drive signal to the RF coil unit 13 to transmit each RF pulse. The RF coil unit 13 forms a high-frequency magnetic field for exciting spins in the body of the subject SU within the static magnetic field space. The formation of the high frequency magnetic field is called transmission of an RF excitation signal, and the RF excitation signal is called RF pulse.

Electromagnetic waves or magnetic resonance (MR) signals by which the excited spins are produced, are received by the RF coil unit 13. The data acquisition unit 5 is connected to the RF coil unit 13. The data acquisition unit 5 collects or acquires the echo signals (or MR receive signals) received by the RF coil unit 13 as digital data.

The MR signals detected by RF coil unit 13 and acquired by the data acquisition unit 5 become signals in a frequency domain (frequency region), e.g., a Fourier space.

Since the MR signals are encoded on a two-axis basis by the gradients in the phase-axis and frequency-axis directions, the MR signals are obtained as signals in a two-dimensional Fourier space when a frequency space is illustrated in the Fourier space. The two-dimensional Fourier space is also called “k space”.

The phase encode gradient magnetic field and the frequency encode (readout) gradient magnetic field determine a sampling position of each signal in the two-dimensional Fourier space.

The sequence controller 6 is connected to the gradient coil driver 3, the RF coil driver 4 and the data acquisition unit 5.

The sequence controller 6 is constituted using a first signal arithmetic control processing means, for example, a first computer or the like. The sequence controller 6 has an unillustrated first memory. The first memory stores therein programs and various data for the sequence controller 6.

Various functions of the sequence controller 6 are realized by allowing the first computer to execute the programs stored in the first memory.

The output side of the data acquisition unit 5 is connected to the data processor 7. Data collected or acquired by the data acquisition unit 5 are inputted to the data processor 7. The data processor 7 is constituted using a second signal arithmetic control processing means different from the first signal arithmetic control processing means that constitutes the sequence controller 6, for example, a second computer or the like. The data processor 7 has an unillustrated second memory. The second memory stores therein programs and various data for the data processor 7.

The data processor 7 is connected to the sequence controller 6. The data processor 7 is high-ranked in the sequence controller 6 and generally controls or manages various control processes in the sequence controller 6. Its specific method is realized by allowing the data processor 7 to execute the corresponding program stored in the second memory.

The data processor 7 stores the data acquired by the data acquisition unit 5 in the corresponding memory. A data space corresponding to the above-described k space is formed in the memory. The data processor 7 frequency-converts, e.g., two-dimensionally inverse-Fourier transforms the data in the k space to reconstruct a photographed image.

The display unit 8 is connected to the data processor 7. The display unit 8 is constituted of a graphic display or the like. The display unit 8 displays thereon the reconstructed image and various information outputted from the data processor 7.

The operation unit or console 9 is connected to the data processor 7. The operation console 9 is constituted of a keyboard or the like equipped with a pointing device. The operation console 9 is operated by an operator (or user) and inputs various commands or information or the like such as a pulse sequence database (PSD) to the data processor 7.

The operator (or user) is able to operate the MRI apparatus 100 interactively (in an interactive manner) through the display unit 8 and operation console 9 operated under the control of the data processor 7.

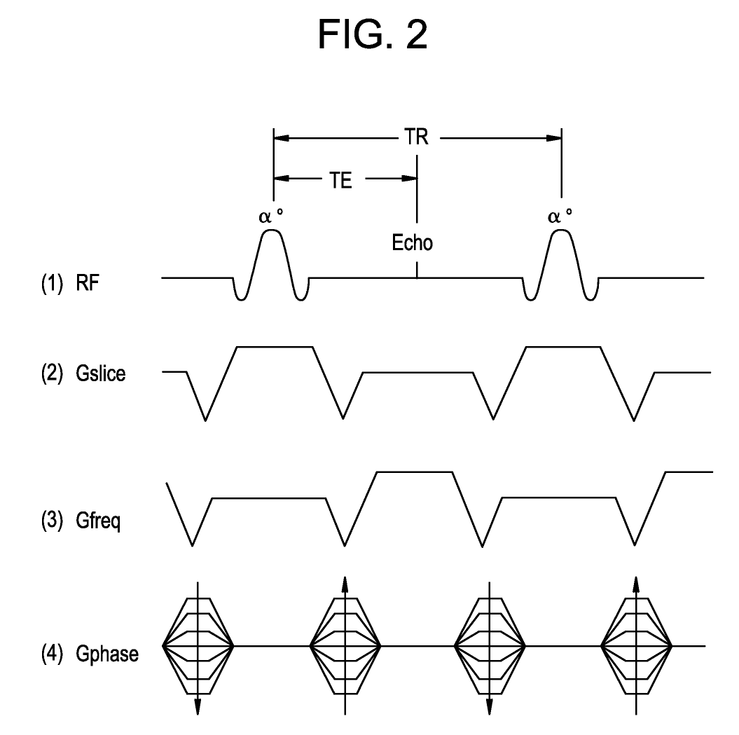

A pulse sequence for scan in an SSFP state is shown in FIG. 2.

The pulse sequence proceeds from left to right. In FIG. 2, (1) indicates a pulse sequence of an RF signal. Any of (2) through (4) indicates a pulse sequence of gradient magnetic fields. (2) indicates a slice gradient Gslice, (3) indicates a frequency encode gradient Gfreq, and (4) indicates a phase encode gradient Gphase, respectively. Incidentally, a static magnetic field is always applied at a constant magnetic field strength.

As shown in FIG. 2, spin excitation based on α° pulses is carried out. The spin excitation is selective excitation under the slice gradient Gslice. The spin excitation is repeatedly performed in a cycle TR. The cycle TR is also called pulse repetition time. 1TR corresponds to one view.

An echo is read out based on the frequency encode gradient Gfreq applied during one TR. Incidentally, the echo is expressed in its center signal. The time from the center of the α° pulse to the center of the echo is an echo time TE. The echo time is called simply “TE” below.

The frequency encode gradient Gfreq is set in such a manner that TE=TR/2 normally. When it is desired to image or photograph water and fat in separate form, TE is further set so as to assume 1/m of the time at which the phase difference between water and fat becomes 2π. This is performed through the setting of TR. For example, m is 4. At this time, the phase difference between water and fat reaches π/2. Incidentally, m is not necessarily limited to 4.

The phase encode gradients Gphase are applied immediately after the spin excitation during one TR and immediately before the following spin excitation during one TR respectively. These respective pairs of phase encode gradients Gphase are symmetric with respect to one another in size and polarity. Thus, winding-up of phase encode is performed by the front phase encode gradient Gphase, and rewinding of phase encode is performed by the rear phase encode gradient Gphase. The amount of phase encode is changed every 1TR.

In the MRI apparatus 100 according to the present embodiment, phase cycling at the execution of the data acquisition or collection as described above is performed while the amount of increment/decrement in the phase (i.e., RF transmission phase) of each α° pulse is being changed upon data acquisition in a positive low frequency domain on the k space and upon data acquisition in a negative low frequency domain on the k space.

The amount of increment/decrement in the RF transmission phase changes so as to differ at the start of data acquisition and at the end thereof. The amount of its change varies between 0 and a predetermined value. Since a steady state must be maintained during FISP, the predetermined value is set to such a degree that the amount of increment/decrement in the RF transmission phase is gradually changed such that the steady state can be maintained on a pseudo basis in the present invention. A method for determining the predetermined value is not limited by or to the present invention. For example, values obtained empirically can be used.

This will be described below citing examples specifically.

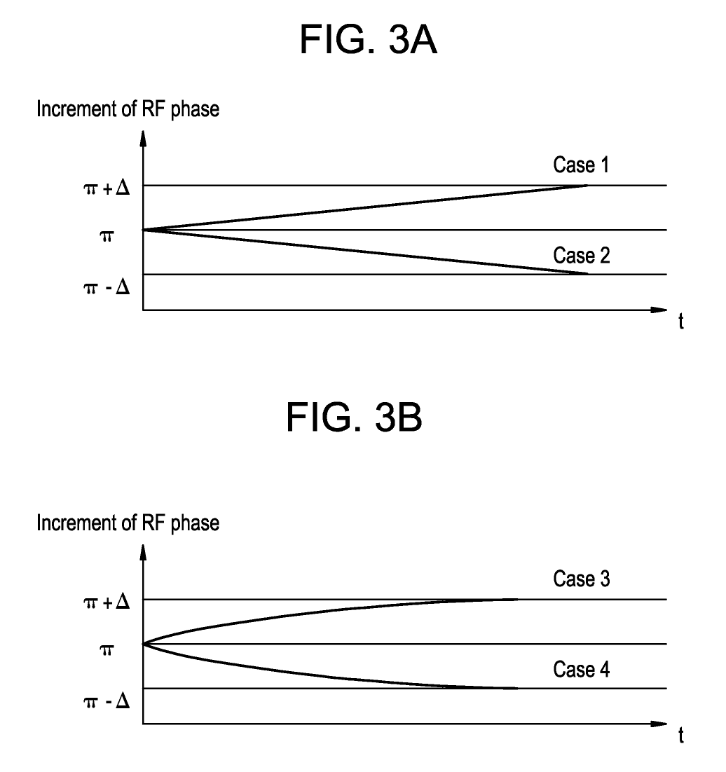

FIG. 3 is a diagram for describing changes in the amount of increment/decrement in the RF transmission phase in the MRI apparatus 100 according to the present embodiment.

The horizontal axis in FIG. 3 indicates time t, and the vertical axis indicates the phase, respectively.

As shown in FIG. 3, the MRI apparatus 100 according to the present embodiment changes the amount of increment/decrement in the RF transmission phase over the entire scan.

A case 1 shown in FIG. 3(a) indicates that the amount of increment/decrement in the phase that was π at the start of the scan in the positive low frequency domain is gradually increased and the amount thereof has reached π+Δ at the end of the scan in the negative low frequency domain. Δ can be changed arbitrarily.

A case 2 shown in FIG. 3(a) indicates that the phase that was π at the start of the scan is gradually decreased and the phase has reached π−Δ at the end of the scan.

Incidentally, the case 1 and case 2 shown in FIG. 3(a) are shown as examples and the amount of increment/decrement in the RF transmission phase increases (or decreases) linearly. However, the present invention is not limited to it. As in a case 3 and a case 4 shown in FIG. 3(b), for example, the rate of change may not be kept constant with respect to the time. That is, in the present invention, the amount of increment/decrement in the RF transmission phase may increase (or decrease) monotonously between the scan's start time and the scan's end time.

By reading echoes by the phase encode and the frequency encode as described above, the data in the k space are sampled.

Incidentally, the positions on the k space, for acquiring data are changed depending upon the time in the MRI apparatus 100 according to the present embodiment.

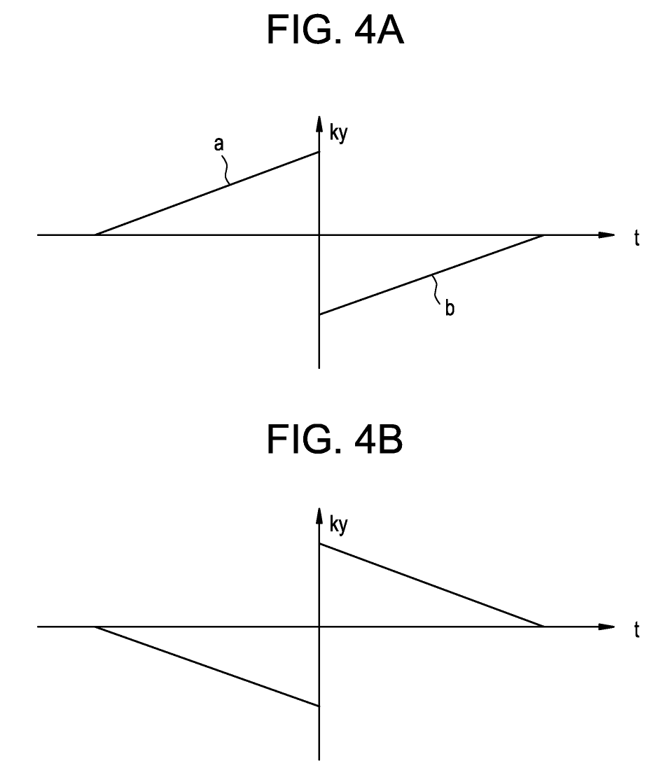

FIG. 4 is a diagram showing the relationship between time and the positions where the collection of data on the k space is being performed.

The horizontal axis t shown in FIG. 4 indicates a time base, and the vertical axis ky indicates a phase axis of the k space.

Incidentally, a description has been made of a two-dimensional scan in FIG. 4. A three-dimensional scan will be described later.

FIG. 4(a) shows one example of the relationship between the positions and time at which data acquisition on the k space is being performed.

Linear curves a and b shown in FIG. 4(a) indicate regions in which data are collected at that time.

In the MRI apparatus 100 according to the present embodiment, as shown in FIG. 4(a), a positive low frequency domain (portion near the center of the k space) is gradually scanned with the elapse of time after the start of scanning (linear curve a). After the elapse of a predetermined time, a negative low frequency domain is scanned (linear curve b).

Even other than one example shown in FIG. 4(a), such a configuration that as shown in FIG. (b), a negative low frequency domain is scanned after the start of scanning, and a positive domain is scanned after the elapse of a predetermined time, may be taken.

Incidentally, FIG. 3 and FIG. 4 are coincident in horizontal axis (time base t) with each other. Allowing them to correspond to each other makes it possible to recognize the elapse of time after the scan start, the amount of increment/decrement in the RF transmission phase at that time, and at which domain scanning is done at that time.

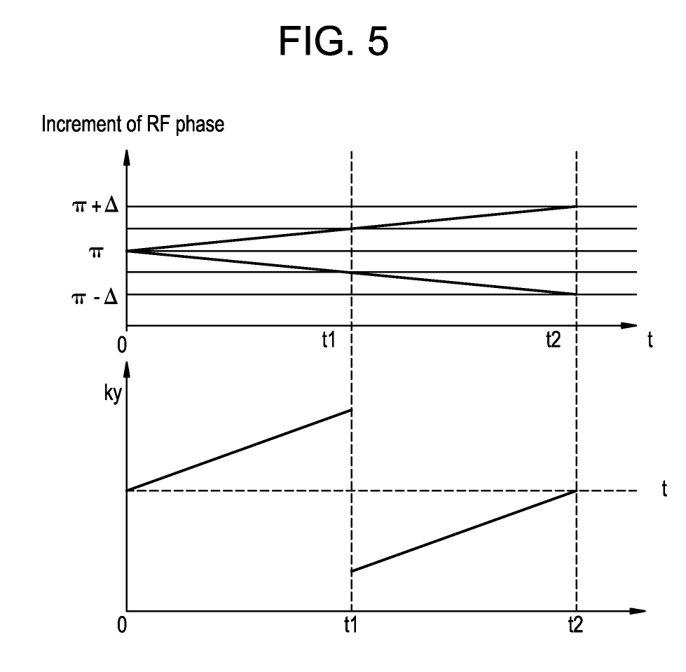

FIG. 5 is a diagram showing correspondences between the example shown in FIG. 3(a) and the example shown in FIG. 4(a). Further, FIG. 5 is a diagram showing the elapse of time, changes in the amount of increment/decrement in the RF transmission phase, and scanned locations in the k space.

As shown in FIG. 5, the collection of data in the amount π of increment/decrement in the RF transmission phase from the positive low frequency domain is dominant between a time 0 and a time t1. The collection of data in the amount π+Δ of increment/decrement in the RF transmission phase at the negative low frequency domain is dominant till a time t2 (scan end time) from the elapse of the time t1.

Incidentally, the case shown in FIG. 5 is illustrated as one example. In the present invention, other cases may also be taken as described above.

Since the locations where the band artifacts appear depending upon the amount of increment/decrement in the RF transmission phase differ as mentioned above, the positions where the band artifacts occur are shifted in the conventional phase cycling method to obtain plural images, and these images are combined together to generate a band artifact-free image. However, the MRI apparatus 100 according to the present embodiment combines the data on the k space.

The steady state must be maintained to execute the phase cycling method. In the MRI apparatus 100 according to the present embodiment, however, the steady state can be held on a pseudo basis because the amount of increment/decrement in the RF transmission phase is gradually changed over the entire scan as mentioned above.

According to the MRI apparatus 100 showing the present embodiment as mentioned above, the amount of increment/decrement in the RF transmission phase is gradually changed with time. Therefore, the time provided for waiting becomes unnecessary upon the change in phase until magnetization is brought to the steady state. Thus, the acquisition of data by the phase cycling method can be done in the same time as when the phase cycling method is not used.

A modification of the MRI apparatus 100 described in the above embodiment will be explained below.

<Modification 1>

The present modification 1 will explain a case in which a half Fourier method is applied to the present invention.

The present modification 1 is also similar to the above embodiment in terms of the configuration or the like of the apparatus.

The half Fourier method is a method wherein when measuring data on a k space are real, an actual data measurement is performed only in a region of more than half of the k space, and the remaining data are obtained by calculation, using the fact that they are placed in the relationship of a complex conjugate with respect to one another. In the half Fourier method, data in the remaining half region can be obtained by calculating conjugate complex numbers of the collected data.

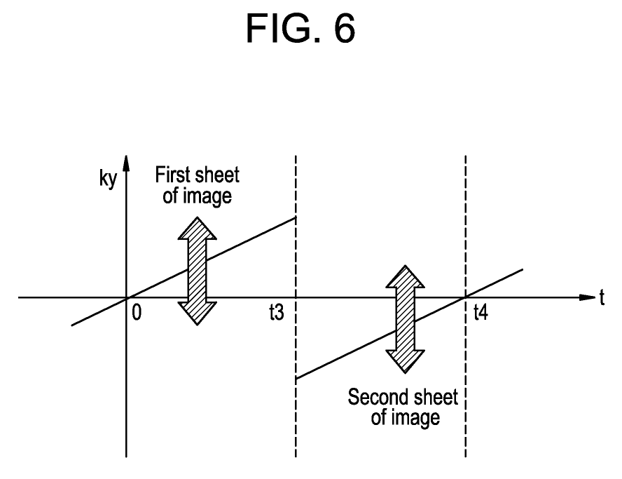

FIG. 6 shows one example of the relationship between positions and time at which data acquisition on the k space is being performed upon data acquisition in the present modification 1.

The horizontal axis in FIG. 6 indicates time t and the vertical axis indicates a phase axis ky of the k space, respectively.

As shown in FIG. 6, data in a positive low frequency domain of the k space are collected from a time t0 to a time t3, and data in a negative low frequency domain thereof are collected from a time t3 to a time t4. The modification 1 is similar to the above embodiment up to here.

In the modification 1 as described in the above embodiment, the data are collected while the amount of increment/decrement in the RF transmission signal is being changed gradually. Then, other images are created based on the data collected from the time t0 to the time t3 and the data collected from the time t3 to the time t4, after which images are combined together by the half Fourier method on the basis of these images.

That is, the data are combined on the k space in the above embodiment, whereas in the present modification 1, the other images are created, followed by combination of the images.

As described above, the MRI apparatus 100 according to the present modification 1 is capable of eliminating an idling time interval provided to bring magnetization to a steady state, which has been required upon switching the amount of increment/decrement in the RF transmission phase even in the case of the conventional half Fourier method, and shortening the time necessary for the entire scan.

Incidentally, the relationship between the positions and time at which the data acquisition on the k space shown in FIG. 6 is being performed, is one example. In the present invention, the negative low frequency domain may be scanned from the time t0 to the time t3, and the positive low frequency domain may be scanned from the time t3 to the time t4. <Modification 2>

The present modification 2 will explain a case in which the above embodiment is applied to a three-dimensional scan.

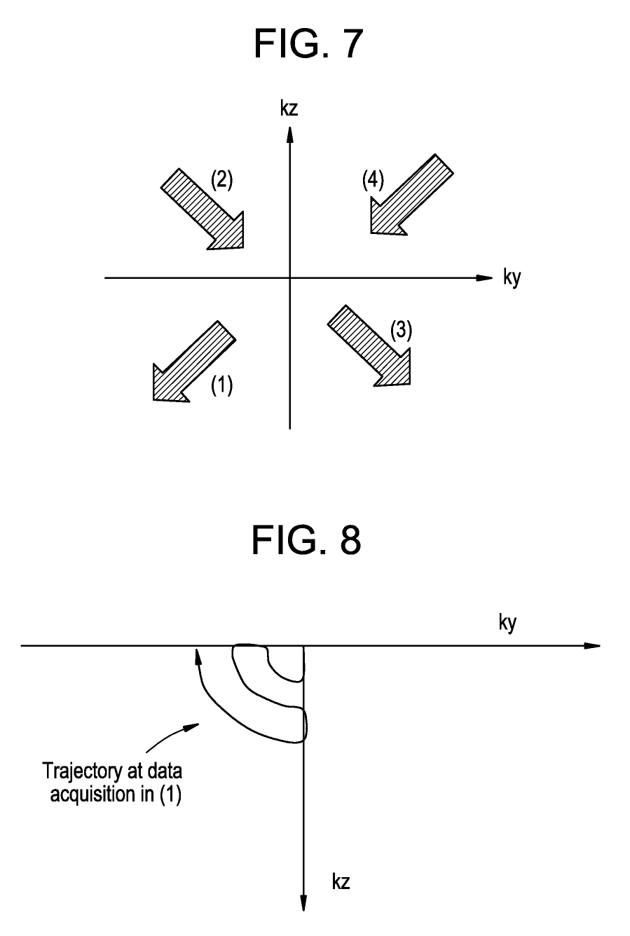

FIG. 7 shows the sequence in which data are collected on a ky-kz plane in a k space upon the three-dimensional scan.

The vertical axis in FIG. 7 indicates kz, and the horizontal axis indicates ky, respectively.

(1) through (4) shown in FIG. 7 show one example of the sequence for collecting the data. As shown in FIG. 7, the collection or acquisition of data is performed in directions indicated by arrows in order of the third, second, fourth and first quadrants.

FIG. 8 shows one example of a trajectory for collecting data in the third quadrant.

As shown in FIG. 8, the acquisition or collection of data is performed outside from the center of the k space. This is similarly done even in the fourth quadrant ((3) of FIG. 7).

In the above (2) and (4), the direction to be scanned is faced in the opposite direction (from the outside to the center) as indicated by arrows in FIG. 7.

Even in the modification 2, the amount of increment/decrement in the RF transmission phase is gradually changed in a manner similar to the above embodiment and modification 1.

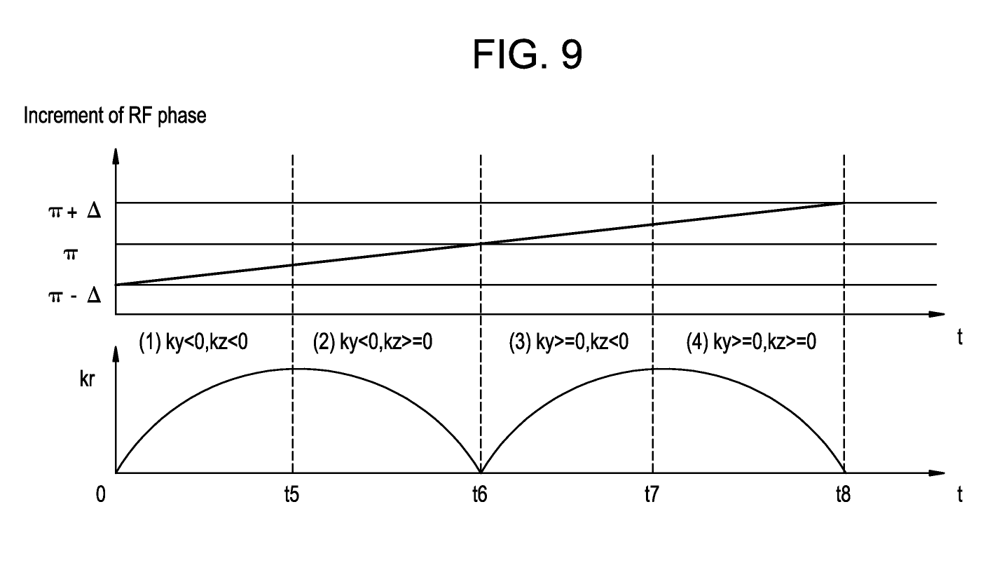

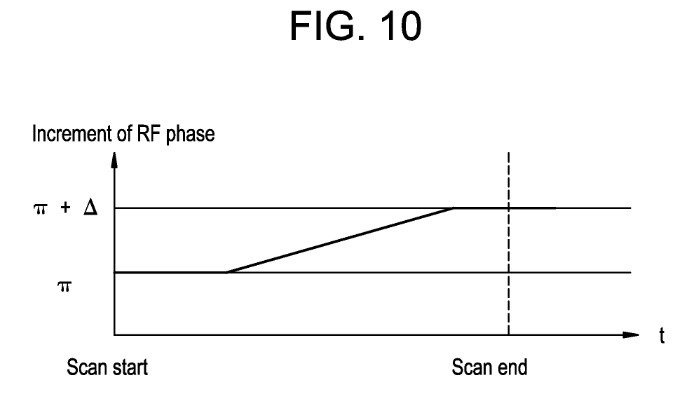

FIG. 9 shows one example of the relationship between the elapse of time, changes in the amount of increment/decrement in an RF transmission phase, and positions where data acquisition on a k space is being performed.

The horizontal axis in FIG. 9 indicates time t, and the vertical axis indicates the phase on the upper side of the figure and indicates a distance kr from the center of the k space on the lower side of the figure. Incidentally, kr is expressed as follows:

kr=\sqrt{ky²+kz²} [Equation 1]

The execution of a scan in the third quadrant shown in FIG. 8 in the amount π−Δ of increment/decrement in the RF transmission phase is dominant from a time t0 to a time t5 as shown in FIG. 9. The execution of a scan in the second quadrant shown in FIG. 8 in the amount π of increment/decrement in the RF transmission phase is dominant from the time t5 to a time t6. The execution of a scan in the fourth quadrant shown in FIG. 8 in the amount π of increment/decrement in the RF transmission phase is dominant from the time t6 to a time t7. The execution of a scan in the first quadrant shown in FIG. 8 in the amount π+Δ of increment/decrement in the RF transmission phase is dominant from the time t7 to a time t8.

In the modification 2 as described above, the MRI apparatus 100 of the present invention can be applied even to the three-dimensional scan. Since the amount of increment/decrement in the RF transmission phase makes it possible to combine data of three patterns (π−Δ, π, π+Δ) in the medication 2, a band artifact can be reduced.

Incidentally, the scan methods shown in FIGS. 8 and 9 are illustrated by way of example. The present invention can be applied if the amount of increment/decrement in the RF transmission phase and the location to be scanned are changed depending upon time.

The present invention is not limited to the above embodiment.

That is, upon implementation of the present invention, various changes, combinations, subcombinations and substitution may be effected on the constituent elements of the above embodiments within the technical scope of the present invention or its equivalent scope.

Although the amount of increment/decrement in the RF transmission phase is set so as to monotonously increment (or decrement) as shown in FIG. 3 in the above embodiment, the present invention is not limited to it. As shown in FIG. 10, for example, the amount thereof remains unchanged for a while after the scan start, and an increment or decrement in the RF transmission phase may be started from a predetermined point of time. That is, in the present invention, the amount of increment/decrement in the RF transmission phase differ upon the scan start and the scan end, and its change may preferably be monotonous to such a degree that a steady state can be held on a pseudo basis.

Many widely different embodiments of the invention may be configured without departing from the spirit and the scope of the present invention. It should be understood that the present invention is not limited to the specific embodiments described in the specification, except as defined in the appended claims.

1. A phase cycling method suitable for use in an SSFP pulse sequence of a gradient echo system which rewinds a phase shift of transverse magnetization generated in a TR by a gradient magnetic field before excitation of the following RF pulse, comprising the step of:
changing an amount of increment/decrement in an RF transmission phase between a data collection start time and a data collection end time in such a manner that the amount of increment/decrement in the RF transmission phase differs upon data collection in a positive low frequency domain on a k space and upon data collection in a negative low frequency domain.

2. The phase cycling method according to claim 1, wherein the amount of change in the amount of increment/decrement in the RF transmission phase makes it possible to vary the amount of increment/decrement in the RF transmission phase from 0 to a predetermined value between the data collection start time and the data collection end time.

3. The phase cycling method according to claim 2, wherein the predetermined value is set to such a degree as to be capable of holding a steady state in such a manner that the amount of increment/decrement in the RF transmission phase changes.

4. The phase cycling method according to claim 3, comprising the step of combining different two images generated based on data in a positive low frequency domain and data in a negative low frequency domain to thereby produce an MR image.

5. The phase cycling method according to claim 3, which is applicable to a three-dimensional scan.

6. A magnetic resonance imaging apparatus using a phase cycling method suitable for use in an SSFP pulse sequence of a gradient echo system which rewinds a phase shift of transverse magnetization generated in a TR by a gradient magnetic field before excitation of the following RF pulse,
wherein an amount of increment/decrement in an RF transmission phase is changed between a data collection start time and a data collection end time in such a manner that the amount of increment/decrement in the RF transmission phase differs upon data collection in a positive low frequency domain on a k space and upon data collection in a negative low frequency domain.

7. The magnetic resonance imaging apparatus according to claim 6, wherein the amount of change in the amount of increment/decrement in the RF transmission phase makes it possible to vary the amount of increment/decrement in the RF transmission phase from 0 to a predetermined value between the data collection start time and the data collection end time.

8. The magnetic resonance imaging apparatus according to claim 7, wherein the predetermined value is set to such a degree as to be capable of holding a steady state in such a manner that the amount of increment/decrement in the RF transmission phase changes.

9. The magnetic resonance imaging apparatus according to claim 8, comprising the step of combining different two images generated based on data in a positive low frequency domain and data in a negative low frequency domain to thereby produce an MR image.

10. The magnetic resonance imaging apparatus according to claim 8, which is applicable to a three-dimensional scan.

11. A method for reducing band artifacts using a magnetic resonance MR imaging system, said method comprising:
transmitting a radio frequency RF pulse during a scanning period using the MR imaging system;
continuously varying a phase of the transmitted pulse during the scanning period; and
generating a magnetic resonance image utilizing data collected while continuously varying the phase of the transmitted pulse.

12. A method in accordance with claim 11, wherein continuously varying a phase of the transmitted pulse further comprises incrementing the phase of the transmission pulse between a data collection start time and a data collection end time.

13. A method in accordance with claim 12, further comprising incrementing the phase of the transmission pulse such that the phase differs upon data collection in a positive low frequency domain on a k space.

14. A method in accordance with claim 13 wherein continuously varying a phase of the transmitted pulse further comprises decrementing the phase of the transmission pulse between a data collection start time and a data collection end time.

15. A method in accordance with claim 14, further comprising decrementing the phase of the transmission pulse such that the phase differs upon data collection in a negative low frequency domain.

16. A method in accordance with claim 11, wherein continuously varying a phase of the transmitted pulse further comprises continuously varying a phase of the transmitted pulse from 0 to a predetermined value between the data collection start time and the data collection end time.

17. A method in accordance with claim 16, further comprising continuously varying a phase of the transmitted pulse from 0 to a predetermined value, wherein the predetermined value is set to such a degree as to be capable of holding a steady state in such a manner that the amount of variation in the RF transmission phase changes.

18. A method in accordance with claim 15, further comprising combining two images generated based on data in a positive low frequency domain and data in a negative low frequency domain to generate the magnetic resonance image.

19. A method in accordance with claim 18, further comprising continuously varying a phase of the transmitted pulse during a three-dimensional scanning period.

20. A method in accordance with claim 11, wherein continuously varying a phase of the transmitted pulse further comprises varying a phase of the transmitted pulse such that the phase of the transmitted pulse is different at the data collection start time than the data collection end time.
